(19) United States
(12) Patent Application Publication
(10) Pub. No.: US 2007/0212488 A1
(43) Pub. Date: Sep. 13, 2007

(54) Pattern transfer method and pattern transfer apparatus

(76) Inventor: Kenichi Murooka, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/522,397

(22) Filed: Sep. 18, 2006

(30) Foreign Application Priority Data
Mar. 8, 2006 (JP) 2006-063268

(51) Int. Cl. B05D 5/00; C03C 25/68; B05C 1/00

(52) U.S. Cl. 427/256; 216/54; 118/200

(57) ABSTRACT

A pattern transfer method includes performing positioning between a transfer position of a pattern forming surface of a transfer original plate on which a pattern to be transferred is formed and a transferred position of a transferred surface of a transferred substrate to which the pattern is to be transferred; contacting the pattern forming surface with the transferred surface; and partly correcting the positional deviation between the transfer position of the pattern forming surface and the transferred position of the transferred surface in the in-plane direction, after the positioning is performed.

### CROSS-REFERENCE TO RELATED APPLICATIONS

This application is based upon and claims the benefit of priority from the prior Japanese Patent Application No. 2006-63268, filed on Mar. 8, 2006; the entire contents of which are incorporated herein by reference.

### BACKGROUND OF THE INVENTION

1. Field of the Invention

The present invention relates to a pattern transfer method by a same size contact transfer and a pattern transfer apparatus.

2. Description of the Related Art

As the integration of a semiconductor device is increased in recent years, a circuit pattern for an LSI device constituting the semiconductor device has been more and more scaled down. In the microfabrication of the circuit pattern of the LSI device, not only the critical dimension is reduced, but also the enhancement in the dimensional precision and positional precision of the circuit pattern is required. Therefore, a great load is imposed on the lithography technique for forming a pattern, which entails an increase in cost for a lithography process that accounts for most of a current mass-production cost, i.e., entails an increase in a production cost.

Conventionally, a reduction projection exposure technique using ultraviolet light is a mainstream of a lithography technique for a mass-production. However, as the wavelength of the ultraviolet light used for an exposure has been reduced, the cost for a projection optical system has rapidly been increased. In order to absorb the increase in the device cost even in a small amount, a chemically amplified high-sensitive resist is used under the pressure of necessity, and consequently, it becomes difficult in principle to reduce the edge roughness of the resist than the acid diffusion length. Therefore, the influence given to the pattern dimension cannot be neglected.

On the other hand, attention has been paid to a same size, namely one-to-one contact transfer represented by an imprint lithography as a technique for fundamentally solving the problem of the reduction projection exposure. An expensive projection optical system is unnecessary in the same size contact transfer, so that it is possible to dramatically reduce the device cost. A chemically amplified resist is also unnecessary in the same size contact transfer, so that it is possible to prevent the edge roughness of the resist.

However, the same size contact transfer involves a problem for securing the positional precision. Particularly, with the enhancement in the positional precision required for forming fine patterns, the in-plane distortion due to the deformation of the base substrate is no longer negligible. Therefore, it is inevitable to introduce some new technology. A technique for changing the height of the mask substrate has conventionally been disclosed in, for example, JP-A 2002-289560 (KOKAI) in order to eliminate the non-uniformity in the pressing pressure at the pressing surface upon the pressing in the imprint lithography.

However, the above-mentioned conventional technique aims to eliminate the non-uniformity in the pressing pressure at the pressing surface upon the pressing, and the countermeasure for the partial in-plane distortion is not recognized as a subject. In the same size contact transfer, the precision in the positioning of the transfer pattern becomes tough with the size reduction of the pattern in microfabrication, whereby it is feared that the in-plane distortion of the base pattern caused by the deformation in the plane of the base substrate or the in-plane distortion caused by the deviation of the surface of the base substrate from the flat surface has a non-negligible size.

### SUMMARY OF THE INVENTION

According to one aspect of the present invention, a pattern transfer method includes performing positioning between a transfer position of a pattern forming surface of a transfer original plate on which a pattern to be transferred is formed and a transferred position of a transferred surface of a transferred substrate to which the pattern is to be transferred; contacting the pattern forming surface with the transferred surface; and partly correcting the positional deviation between the transfer position of the pattern forming surface and the transferred position of the transferred surface in the in-plane direction, after the positioning is performed.

According to another aspect of the present invention, a pattern transfer apparatus includes a press-contact unit that presses a pattern forming surface of a transfer original plate on which a pattern to be transferred is formed and a transferred surface of a transferred substrate to which a resist film is to be applied and the pattern is to be transferred, thereby bringing the pattern forming surface and the transferred surface into contact with each other; a positioning unit that positions the transfer position of the pattern forming surface and the transferred position of the transferred surface; a positional deviation correcting unit that partly corrects the positional deviation in the in-plane direction between the transfer position of the pattern forming surface and the transferred position of the transferred surface at the contact surface of the pattern forming surface and the transferred surface; and a light source that irradiates light to expose the resist film on the transferred substrate.

### BRIEF DESCRIPTION OF THE DRAWINGS

FIG. 1 is a constructional view showing a pattern transfer apparatus according to the first embodiment of the present invention;

FIG. 2A is a diagram showing a principle of a correction in the pattern transfer apparatus according to the first embodiment;

FIG. 2B is a view showing an area A in FIG. 2A as enlarged;

FIG. 3A is a diagram showing a principle of a correction in the pattern transfer apparatus according to the first embodiment;

FIG. 3B is a view showing an area B in FIG. 3A as enlarged;

FIG. 4 is a flowchart for explaining a process flow of a pattern transfer method according to the first embodiment;

FIG. 5 is a flowchart for explaining a process flow of a pattern transfer method according to the second embodiment;

FIG. 6A is a flowchart for explaining a process flow of a pattern transfer method according to the third embodiment;

FIG. 6B is a flowchart for explaining a process flow of a pattern transfer method according to the third embodiment;

FIG. 7 is a constructional view showing a pattern transfer apparatus according to the fourth embodiment;

FIG. 8 is an equivalent circuit diagram showing a structure of a mask substrate of the pattern transfer apparatus according to the fourth embodiment;

FIG. 9 is a flowchart for explaining a process flow of a pattern transfer method according to the fourth embodiment;

FIG. 10 is a flowchart for explaining a process flow of a pattern transfer method according to the fifth embodiment;

FIG. 11A is a flowchart for explaining a process flow of a pattern transfer method according to the sixth embodiment; and

FIG. 11B is a flowchart for explaining a process flow of a pattern transfer method according to the sixth embodiment.

### DETAILED DESCRIPTION OF THE PREFERRED EMBODIMENTS

Preferred embodiments of a pattern transfer method and pattern transfer apparatus according to the present invention will be explained hereinafter with reference to the appended drawings. It is to be noted that the present invention is not limited to the following description, and the invention can appropriately be modified within the range not departing from the spirit of the present invention.

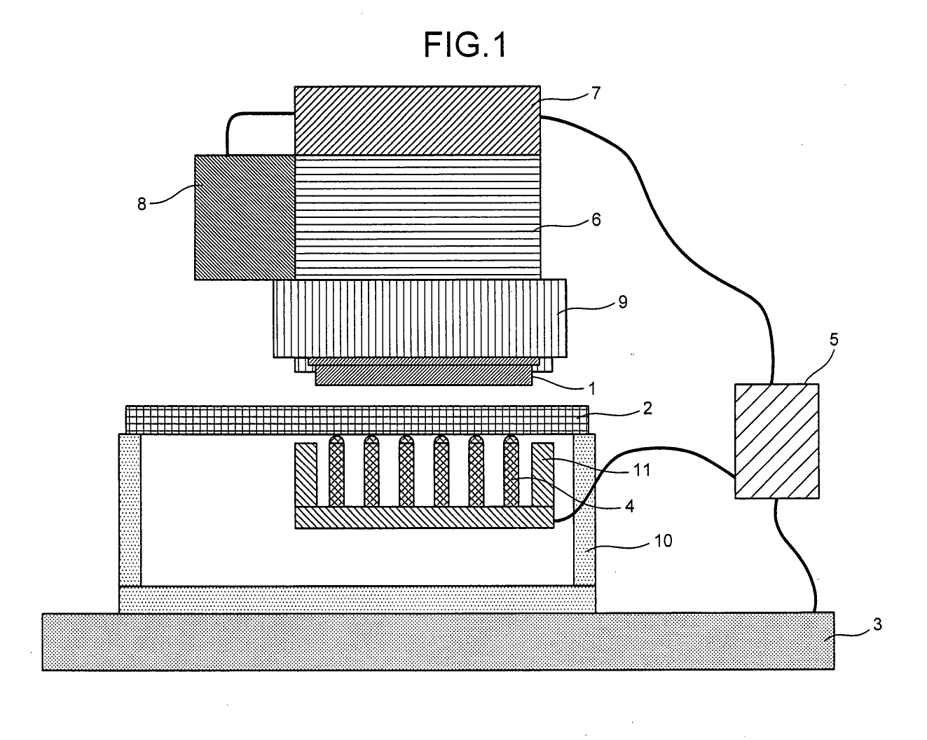

FIG. 1 is a structural view showing a schematic structure of a pattern transfer apparatus according to the first embodiment of the present invention. This pattern transfer apparatus is for realizing a same size contact transfer by the pattern transfer method of the present invention. The pattern transfer apparatus is composed of a mask substrate 1, a wafer stage 3, a height adjusting unit 4, a control unit 5, a positional deviation distribution measuring unit 6, an operation unit 7, a resist-curing light irradiating unit 8, a press-contact unit 9, a wafer chuck 10, and a storing unit 11.

In the pattern transfer apparatus described above according to the present embodiment, the mask substrate 1, which is an original plate, is arranged so as to be opposite to the wafer 2, which is a substrate to which a pattern is to be transferred, as held at the press-contact unit 9. The wafer 2 is held at the wafer chuck 10 so as to be movable in the in-plane direction of the wafer stage 3 thereon. The height adjusting unit 4 that is arranged in a lattice and can partly adjust the height of the wafer 2 is disposed between the wafer 2 held at the wafer chuck 10 and the wafer stage 3. The height adjusting unit 4 is housed in the storing unit 11.

The operation of the wafer stage 3 and the operation of the height adjusting unit 4 are controlled by the control unit 5. The positional deviation measuring unit 6 measures the relative positional deviation between the pattern on the mask substrate and the pattern on the wafer with the mask substrate 1 brought into pressure contact with the wafer 2 by the press-contact unit 9. The result of this measurement is converted into a control signal of the height adjusting units 4 by the operation unit 7, and transmitted to the control unit 5. The resist-curing light irradiating unit 8 irradiates ultraviolet light, which is necessary for curing the resist, to the resist on the wafer 2 through the mask substrate 1 based upon the signal from the control unit 5 and the operation unit 7, after the positioning of the mask substrate 1 and the wafer 2 is completed.

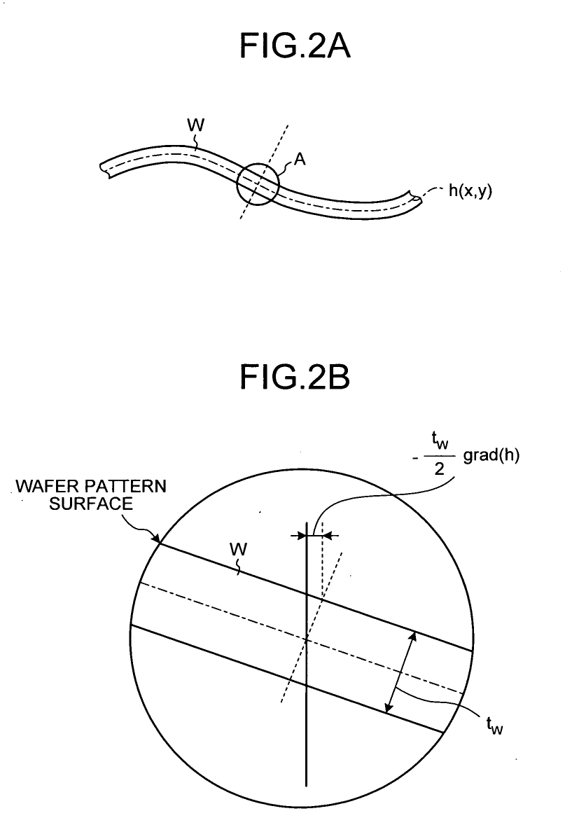

In order to explain that the distortion of the wafer 2 in the in-plane direction can be corrected by the pattern transfer apparatus having the structure shown in FIG. 1, the influence given to the positioning precision by the deformation of the substrate in the height direction will firstly be explained with reference to FIGS. 2A and 2B. FIG. 2A is a schematic sectional view of a wafer W for explaining the principle of the correction in the pattern transfer apparatus according to this embodiment. FIG. 2B is an enlarged view of the area A in FIG. 2A.

When the wafer is deformed in the height direction (in the direction of the thickness of the wafer), the distortion energy in the volume deformation is extremely large, so that the deformation in which the volume is constant generally occurs. Therefore, the central surface of the wafer in the thickness direction (in the height direction) becomes a neutral surface. On this central surface, the displacement in the lateral direction (in the in-plane direction of the wafer) is not produced before and after the deformation. Therefore, the displacement in the lateral direction produced between the neutral surface and the pattern surface provides a positional deviation amount.

Here, the shape of the neutral surface is described as h (x, y) using the coordinate (x, y) in the lateral direction. In this case, the positional deviation amount under the condition where h is not so large is given as −t_{W}/2*grad(h) that is obtained by multiplying the slope of h(x, y) by a half of the thickness t_{W} of the wafer and inversing the sign as shown in FIG. 2B. One example will be given as follows. Supposing that there is a wafer having a thickness of 720 μm and the deformation amount per 1 mm in the height in the lateral direction is 100 nm, the positional deviation amount of 36 nm is produced in this case.

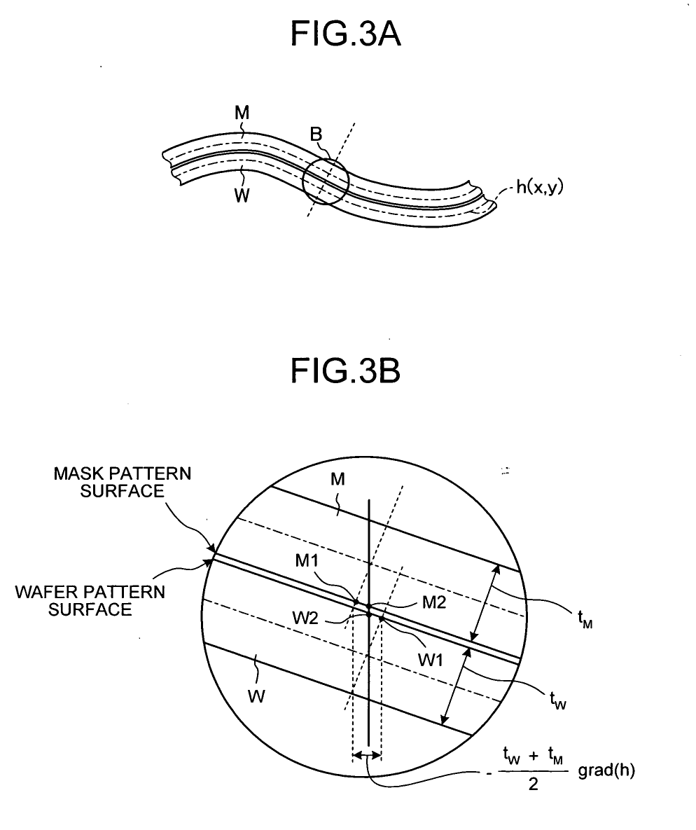

FIG. 3A is a schematic sectional view of the mask substrate M and the wafer W for explaining the principle of the correction in the pattern transfer apparatus according to the embodiment. FIG. 3B is an enlarged view of an area B in FIG. 3A. Since the mask substrate, which is an original plate, is pressed against the wafer which is a substrate to be transferred in the same size contact transfer, the surface shape of the mask substrate goes along the surface shape of the wafer. Further, as for the mask substrate, the central surface in the thickness direction becomes a neutral surface like the above-mentioned case.

As shown in FIG. 3B, the positions where the mask substrate M and the wafer W are overlapped with each other with the wafer W being flat are defined as M1 and W1. Specifically, the transfer position on the mask pattern of the mask substrate M on the design is the position M1. The transferred position on the wafer pattern of the wafer W on the design is the position W1.

On the other hand, the position at the actual transfer on the mask pattern of the mask substrate M is the position M2. The position at the actual transfer on the wafer pattern of the wafer W is the position W2.

Accordingly, from the viewpoint of the original design, the pattern transfer is to be carried out with the position M1 on the mask pattern of the mask substrate M and the position W1 on the wafer pattern of the wafer W overlapped with each other. However, the pattern transfer is actually carried out with the position M2 on the mask pattern of the mask substrate M and the position W2 on the wafer pattern on the wafer W overlapped with each other.

Therefore, the positional deviation amount upon the pattern transfer obtained by putting together the deformation of the pattern of the wafer and the deformation of the pattern of the mask substrate is given as (t_{W}+t_{M})/2*grad(h), supposing that the thickness of the mask substrate is defined as t_{M}. One example will be given as follows. Supposing that the thickness of the wafer is 720 μm, the thickness of the mask substrate is 200 μm, and the deformation amount in the height direction is 100 nm per 1 mm in the lateral direction, the positional deviation amount of 46 nm is produced in this case.

Accordingly, the height adjusting unit is designed so as to be capable of producing a small displacement of about ±1 μm, whereby the correction of the partial positional deviation of about several tens nm in the transfer region is made possible. In general, the allowable value of the positional deviation amount is not more than a third of the critical dimension. Therefore, in the generation in which the critical dimension is not more than 45 nm, it is sufficient that the positional correction to the above-mentioned degree is made possible.

In the same size contact transfer, the mask substrate is pressed against the wafer. Therefore, the height adjusting unit 4 only has force for pushing up the wafer, so that the height adjusting unit 4 can be manufactured with simple structure and reduced cost. On the other hand, in a lithography in which the mask substrate is not pressed against the wafer, the height adjusting unit at the back surface of the wafer is required to provide not only a pushing operation but also a pulling operation when there is a need to form a concave surface. Therefore, some idea is demanded such as forming an imperceptible vacuum chuck.

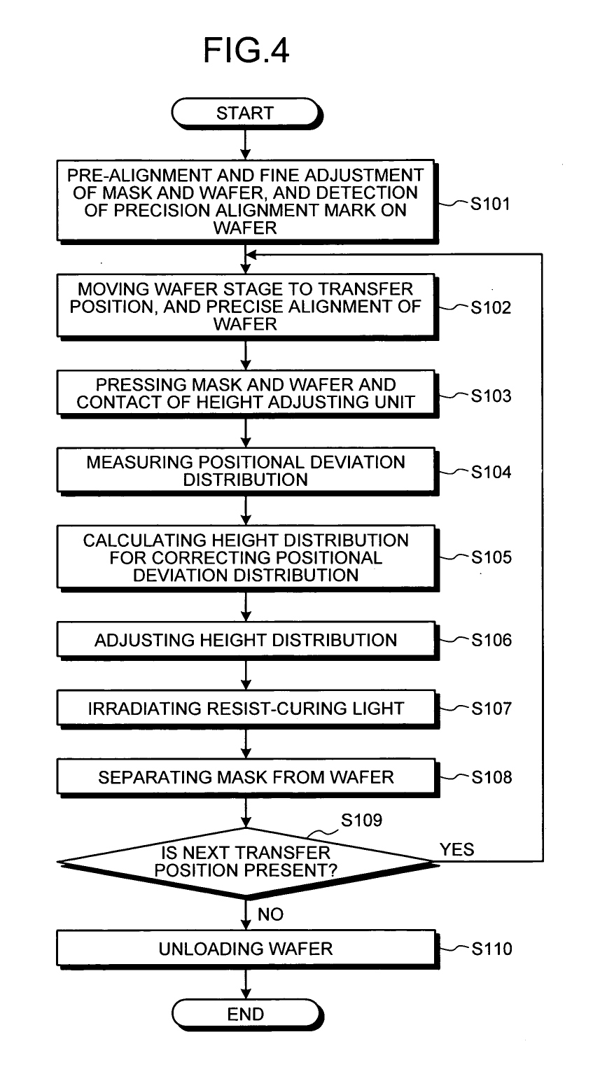

Subsequently, the actual pattern transfer method using the transfer apparatus according to the present embodiment will be explained with reference to FIG. 4. FIG. 4 is a flowchart for explaining a process flow of the pattern transfer according to the present embodiment. Firstly, a pattern for detecting the positional deviation is formed beforehand on the mask substrate 1, which is an original plate, with the circuit pattern. It is to be noted that a part of the circuit pattern may be used for the detection of the positional deviation.

The peripheral support frame of the mask substrate 1 is made of, for example, a quartz glass having a thickness of 6.1 mm, and a pattern forming area is made of, for example, a quartz glass having a thickness of 200 μm. The wafer 2, which is a substrate to which a pattern is to be transferred, is, for example, a silicon wafer having a thickness of 720 μm. A base pattern is formed beforehand on the wafer 2, and ultraviolet curing type resist is applied thereon. The base pattern here includes the pattern for the detection of the positional deviation with the circuit pattern. It is to be noted that a part of the circuit pattern may also be used for the detection of the positional deviation.

The prepared mask substrate 1 is subject to a rough adjustment (pre-alignment) of the position in the horizontal direction and the rotation in the horizontal plane by a pre-alignment mechanism not shown (step S101), and then, fixed to the mask substrate chuck at the press-contact unit 9. Then, a fine adjustment in the position in the horizontal direction and the rotation in the rotating direction is performed by using a reference mark on the wafer stage 3 (step S101).

The wafer 2 having the resist applied thereon is also subject to a rough adjustment (pre-alignment) in the position in the horizontal direction and the rotation in the horizontal plane with a notch defined as a reference by a pre-alignment mechanism not shown, like the mask substrate (step S101), and then, fixed to the wafer chuck 10 on the wafer stage 3. The wafer 2 is fixed to the wafer chuck 10 by utilizing the portion of the periphery of the wafer 2 where the pattern is not formed.

Subsequently, the precision alignment mark on the wafer 2 is detected, whereby the fine adjustment of the position of the wafer in the horizontal direction and the direction of rotation is performed (step S101). By detecting the precision alignment mark on the wafer 2, the positional coordinate of the base pattern on the wafer is recorded as a value to the wafer stage coordinate at this stage to form a map centered at the base pattern. This map is used as the value of the center coordinate upon the transfer.

The height adjusting unit 4 is composed of the piezoelectric devices made of PZT (lead zirconate titanate) arranged in a lattice at an interval of 1 mm. 875 piezoelectric devices (35×25) in total are stored in the storing unit 11 so as to correspond to the shot (transfer) size of 32 mm×22 mm corresponding to the area where the pattern is formed on the wafer 2 with one transfer.

The movable region of each of the piezoelectric devices in the height direction (the thickness direction of the wafer 2 upon the transfer process) can be, for example, ±1 μm. The height adjusting unit 4 applies predetermined voltage to each of the piezoelectric devices in accordance with the signal from the control unit 5, and the height of each of the piezoelectric devices is adjusted, to thereby form a desired height distribution. Further, the overall of the storing unit 11 is movable in the vertical direction. With this configuration, when the transfer process is not performed, in particular, when the wafer 2 is moved to the next transfer region by the operation of the wafer stage 3, the height adjusting unit 4 can be withdrawn from the back surface of the wafer 2 by the movement of the whole storing unit 11.

Then, at the stage where the mask substrate 1 and the wafer 2 are placed in a predetermined state before the above-mentioned pattern transfer, the wafer stage 3 is moved to the position of the center coordinate of the first shot (transfer) of the wafer 2 to perform a precise alignment of the wafer 2 (step S102), like the normal pattern transfer apparatus. Specifically, positioning is performed between the center coordinate of the first shot (transfer) of the wafer 2 and the center coordinate of the mask substrate 1. Subsequently, the press-contact unit 9 and the storing unit 11 are driven to press the mask substrate 1 against the wafer 2 and bring the height adjusting unit 4 into contact with the back surface of the wafer 2 (the surface of the wafer 2 opposite to the mask substrate 1) (step S103).

With this state, the positional deviation amount between the positional deviation detecting pattern on the mask substrate 1 and the positional deviation detecting pattern on the wafer 2 are optically measured at predetermined position using the positional deviation distribution measuring unit 6, whereby the positional deviation distribution is measured (step S104). Supposing that the result of the measurement is defined as u(x, y) (notably, u is a two-dimensional vector amount), the positional deviation amount u(x, y) can be cancelled according to the above-mentioned principle, if h=2/(t_{W}+t_{M})∫udl by using a linear integration from the obtained u(x, y). Since the u(x, y) is actually not a continuous value but a discrete value, the integration is approximated with the sum, and the map h1 of the approximate value of h is obtained at the operation unit 7.

The position of the positional deviation detecting pattern does not always agree with the lattice position of the height adjusting unit 4. Therefore, the operation unit 7 makes an approximate polynomial to the map h1 of the approximate value to obtain each coefficient of the polynomial by the least squares method. The obtained coefficient of the polynomial is sent to the control unit 5 as data.

The control unit 5 obtains the height distribution information for correcting the positional deviation distribution by using the coefficient of the polynomial received from the operation unit 7, and calculates the correction height distribution information h2 that should be given to each lattice point of the height adjusting unit 4 (step S105). Then, the control unit 5 converts the calculated correction height distribution information h2 into the voltage that should be applied to each piezoelectric device of the height adjusting unit 4, and applies the voltage to the piezoelectric device to drive the same for adjusting the height distribution in the plane at the transfer position (step S106). The positional deviation between the mask substrate 1 and the wafer 2 can be cancelled by this height adjustment.

Next, the control unit 5 confirms the completion of the process for adjusting the height distribution in the plane at the transfer position, and then, transmits to the resist-curing light irradiating unit 8 an instruction signal for the light irradiation for the resist curing. The resist-curing light irradiating unit 8 irradiates ultraviolet light for the resist curing from the back surface of the mask substrate 1 in accordance with the instruction signal from the control unit 5, thereby transferring the resist pattern having the same shape of the pattern on the mask substrate 1 on the wafer 2 (step S107).

According to need, the positional deviation distribution may be measured again before the irradiation of the ultraviolet light for confirming whether the positional deviation is cancelled or not. With this operation, a transfer with more reliability can be performed. Further, the fine adjustment in the height may be performed again in accordance with the result of the re-measurement of the positional deviation distribution. This can more surely cancel the positional deviation, so that a transfer having more reliability can be performed. A feedback loop may be provided between the measurement of the positional deviation distribution and the height adjustment.

After the pattern is transferred by the irradiation of the ultraviolet light, the press-contact unit 9 and the storing unit 11 are separated from the wafer 2 (step S108). Then, the control unit 5 determines whether the next transfer position is present or not (step S109). When the next transfer position is present (Yes at step S109), the program returns to step S102 so as to drive the wafer stage 3 to move the same to the center coordinate of the next shot (transfer). Then, the transfer process is repeated by the same process.

On the other hand, when the next transfer position is not present (No at step S109), i.e., when all the desired shots (transfers) on the wafer 2 are completed, the press-contact unit 9 and the storing unit 11 are again separated from the wafer 2. After they are sufficiently separated, the wafer 2 on which the pattern has already been transferred is unloaded from the wafer chuck 10 (step S110), whereby a series of transfer process of the wafer 2 is completed. After that, the transfer to the next wafer 2 can be performed by the same process.

The aforementioned series of transfer process is executed using the pattern transfer apparatus according to the present embodiment, whereby a high-quality pattern transfer having very small positional deviation distribution is made possible in which the partial distortion of the wafer 2 in the in-plane direction at the transfer position is corrected and the positioning precision between the mask substrate 1 and the wafer 2 is remarkably enhanced.

In the second embodiment, another pattern transfer method using the pattern transfer apparatus according to the above-mentioned first embodiment will be explained. It is to be noted that, since the pattern transfer apparatus according to this embodiment is the same as that in the first embodiment, FIG. 1 and the above-mentioned explanation are referred to, and the detailed explanation thereof is not repeated.

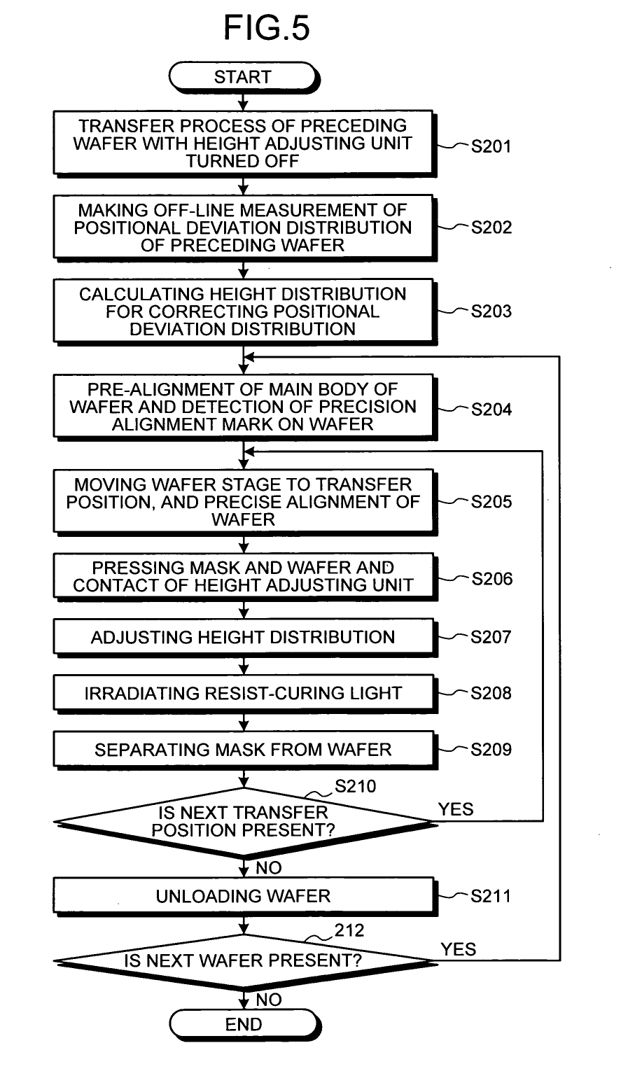

This embodiment explains the pattern transfer method in which the reproducibility in the positional deviation distribution of the wafer is high, such as plural wafers manufactured by, for example, the same lot through the same process. When the reproducibility in the positional deviation distribution is high, and the measurement of the positional deviation distribution for each wafer or the measurement of the positional deviation distribution for each shot in each wafer is unnecessary, the following simple method can be employed. This will be explained hereinafter with reference to FIG. 5. FIG. 5 is a flowchart for explaining a process flow of the pattern transfer method according to this embodiment.

Firstly, a pattern transfer is performed to a dummy wafer (hereinafter referred to as preceding wafer 2a) for measuring the positional deviation distribution and the positional deviation distribution at the shot (transfer) in the wafer. The normal pattern transfer to the preceding wafer 2a is carried out with the height adjusting unit 4 turned off, i.e., with the whole of the height adjusting unit 4 not displaced (step S201). In this pattern transfer, the above-mentioned steps S101 to S103 are executed as the preliminary process.

Next, the preceding wafer 2a to which the pattern has been transferred is unloaded from the pattern transfer apparatus, and the positional deviation distribution u(x, y) is measured by using the off-line positional deviation measuring device (step S202). It is to be noted that the off-line measuring function may be provided to the positional deviation distribution measuring unit 6 of the pattern transfer apparatus for measuring the positional deviation distribution. Further, the obtained positional deviation distribution is input to the operation unit 7, whereby the map h1 of the approximate value is obtained by the same manner as in the first embodiment.

Subsequently, the operation unit 7 makes an approximate polynomial to the map h1 of the approximate value to obtain each coefficient of the polynomial by the same manner as in the first embodiment. The obtained coefficient of the polynomial is sent to the control unit 5 as data. The control unit 5 corrects the height distribution information for correcting the positional deviation distribution using the coefficient of the polynomial received from the operation unit 7, thereby calculating the correcting height distribution information h2 that should be given to each lattice point of the height adjusting unit 4 (step S203).

Next, the pattern transfer to the main body wafer (hereinafter referred to as wafer 2), which is to be a product, is carried out. Since the rough adjustment (pre-alignment) and fine adjustment of the mask substrate 1 has already been completed as the preliminary process, the rough adjustment (pre-alignment) and fine adjustment for the wafer 2 having the resist applied thereon is executed. Specifically, the rough adjustment (pre-alignment) of the position in the horizontal direction and the rotation in the horizontal plane is carried out with the notch defined as a reference by using a pre-alignment mechanism not shown (step S204), like the case of the mask substrate 1, and then, the wafer 2 is fixed to the wafer chuck 10 on the wafer stage 3. The wafer 2 is fixed to the wafer chuck 10 by utilizing the peripheral portion of the wafer 2 where the pattern is not formed.

Subsequently, the precision alignment mark on the wafer 2 is detected, whereby the fine adjustment of the position of the wafer in the horizontal direction and the direction of rotation is performed (step S204). By detecting the precision alignment mark on the wafer 2, the positional coordinate of the base pattern on the wafer is recorded as a value to the wafer stage coordinate at this stage to form a map centered at the base pattern. This map is used as the value of the center coordinate upon the transfer.

Then, at the stage where the mask substrate 1 and the wafer 2 are placed in a predetermined state before the above-mentioned pattern transfer, the wafer stage 3 is moved to the position of the center coordinate of the first shot (transfer) of the wafer 2 to perform a precise alignment of the wafer 2 (step S205), like the normal pattern transfer apparatus. Specifically, positioning is performed between the center coordinate of the first shot (transfer) of the wafer 2 and the center coordinate of the mask substrate 1. Subsequently, the press-contact unit 9 and the storing unit 11 are driven to press the mask substrate 1 against the wafer 2 and bring the height adjusting unit 4 into contact with the back surface of the wafer 2 (the surface of the wafer 2 opposite to the mask substrate 1) (step S206).

Next, the control unit 5 converts the correction height distribution information h2 calculated based on the positional deviation distribution u(x, y) of the preceding wafer 2a into the voltage that should be applied to each piezoelectric device of the height adjusting unit 4, and applies the voltage to the piezoelectric device to drive the same, thereby adjusting the height distribution in the plane at the transfer position (step S207). The positional deviation between the mask substrate 1 and the wafer 2 can be cancelled with this height adjustment.

Next, the control unit 5 confirms the completion of the process for adjusting the height distribution in the plane at the transfer position, and then, transmits to the resist-curing light irradiating unit 8 an instruction signal for the light irradiation for the resist curing. The resist-curing light irradiating unit 8 irradiates ultraviolet light for the resist curing from the back surface of the mask substrate 1 in accordance with the instruction signal from the control unit 5, thereby transferring the resist pattern having the same shape of the pattern on the mask substrate 1 on the wafer 2 (step S208).

After the pattern is transferred by the irradiation of the ultraviolet light, the press-contact unit 9 and the storing unit 11 are separated from the wafer 2 (step S209). Then, the control unit 5 determines whether the next-transfer position is present or not (step S210). When the next transfer position is present (Yes at step S210), the program returns to step S205 so as to drive the wafer stage 3 to move the same to the center coordinate of the next shot (transfer). Then, the transfer process is repeated by the same process. It is to be noted that the pattern transfer to the wafer 2 can be performed at the other transfer position based on the data of the preceding wafer 2a by the same manner as described above.

On the other hand, when the next transfer position is not present (No at step S210), i.e., when all the desired shots (transfers) on the wafer 2 are completed, the press-contact unit 9 and the storing unit 11 are again separated from the wafer 2. After they are sufficiently separated, the wafer 2 on which the pattern has already been transferred is unloaded from the wafer chuck 10 (step S211). After the wafer 2 is unloaded from the wafer chuck 10, the control unit 5 determines whether the next wafer 2 to which the pattern transfer is to be executed is present or not from the presence of the input of a continuation processing signal, for example (step S212).

When there is the next wafer 2 to which the pattern transfer is to be executed (Yes at step S212), the program returns to step S204 to repeat the transfer process. As described above, the pattern transfer to the succeeding wafer 2 of the same lot is carried out, whereby the pattern transfer is made possible in which the partial distortion of the wafer 2 in the in-plane direction is corrected with the equivalent precision.

On the other hand, when the next wafer 2 to which the pattern transfer is to be executed is not present (No at step S212), a series of transfer process to the wafer 2 of the same lot is completed. After that, the pattern transfer to the wafer 2 for each lot can be carried out by performing the process same as that described above to the wafer 2 of the other lot.

In the above-mentioned pattern transfer process, the correction height distribution information h2 calculated using the preceding wafer 2a is used to perform the pattern transfer to the wafer 2. In this case, the pattern transfer process can be executed by using the correction height distribution information h2 different for every transfer position. Further, it is possible to execute the pattern transfer by using the correction height distribution information h2 same for all transfer positions.

According to the pattern transfer method of the present embodiment, a high-quality pattern transfer having very small positional deviation distribution is made possible in which the partial distortion of the wafer 2 in the in-plane direction at the transfer position is corrected and the positioning precision between the mask substrate 1 and the wafer 2 is remarkably enhanced, like the case of the first embodiment.

Further, according to the pattern transfer method of the present embodiment, when the reproducibility of the positional deviation distribution of the wafer is high such as plural wafers manufactured with the same lot through the same process, the data of the preceding wafer 2a is fed back, whereby the partial distortion of the wafer 2 in the in-plane direction is corrected with the equivalent precision without measuring the positional deviation distribution for each wafer, or without measuring the positional deviation distribution for every shot in each wafer. Therefore, the pattern transfer can be carried out with good mass-productivity.

In the third embodiment, another pattern transfer method using the pattern transfer apparatus according to the above-mentioned first embodiment will be explained. It is to be noted that, since the pattern transfer apparatus according to this embodiment is the same as that in the first embodiment, FIG. 1 and the above-mentioned explanation are referred to, and the detailed explanation thereof is not repeated.

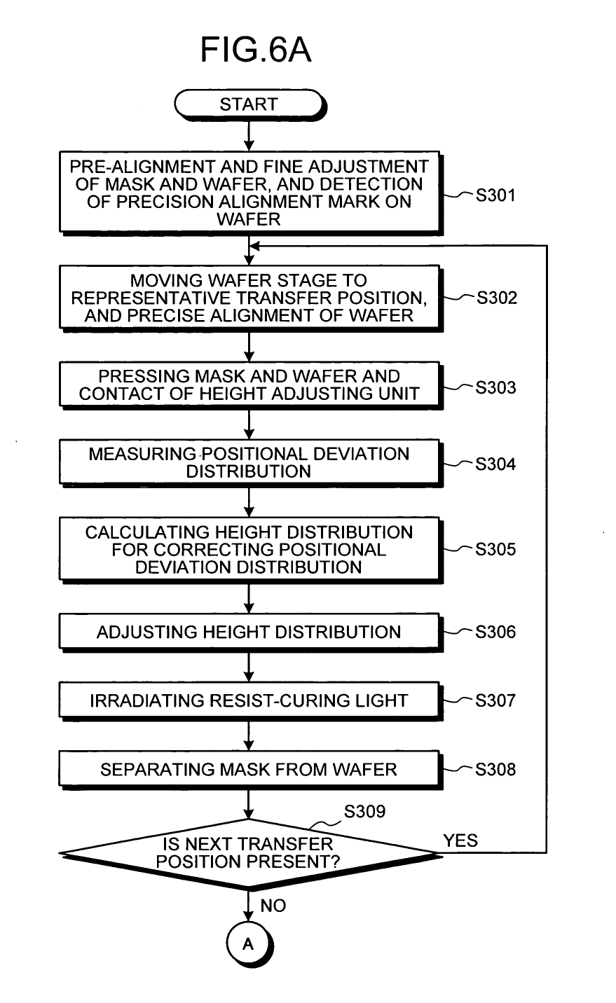

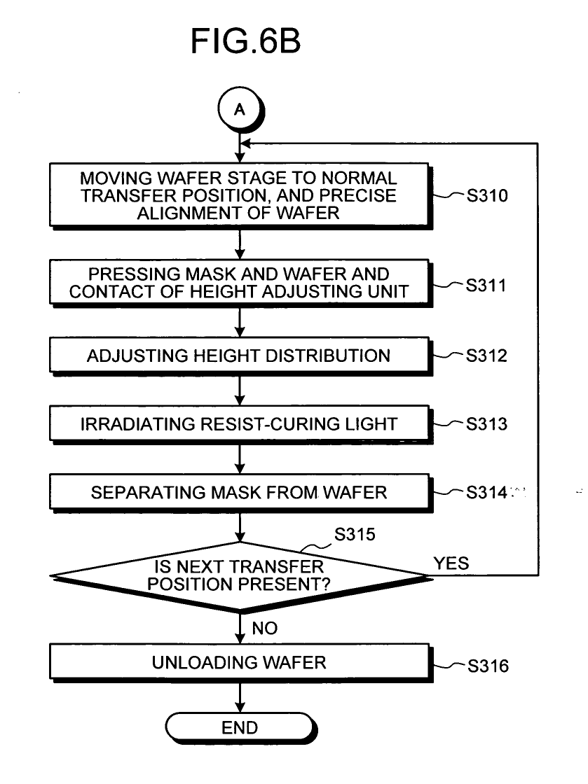

When a great difference is not produced in the positional deviation for every shot (transfer) in each wafer, for example, the following simple method can be employed. In the pattern transfer method according to this embodiment, the positional deviation distribution for the optional representative transfer position among plural transfer positions formed on a single wafer 2 is only measured to calculate the correction height distribution information, and the correction height distribution information at the representative transfer position is applied to the other transfer positions. The pattern transfer method of this embodiment will be explained hereinafter with reference to FIGS. 6A and 6B. FIGS. 6A and 6B are flowcharts for explaining the process flow of the pattern transfer method according to this embodiment.

The prepared mask substrate 1 is subject to a rough adjustment (pre-alignment) of the position in the horizontal direction and the rotation in the horizontal plane by a pre-alignment mechanism not shown (step S301), and then, fixed to the mask substrate chuck at the press-contact unit 9. Then, a fine adjustment in the position in the horizontal direction and the rotation in the rotating direction is performed by using a reference mark on the wafer stage 3 (step S301).

The wafer 2 having the resist applied thereon is also subject to a rough adjustment (pre-alignment) in the position in the horizontal direction and the rotation in the horizontal plane with a notch defined as a reference by a pre-alignment mechanism not shown, like the mask substrate (step S301), and then, fixed to the wafer chuck 10 on the wafer stage 3. The wafer 2 is fixed to the wafer chuck 10 by utilizing the portion of the periphery of the wafer 2 where the pattern is not formed.

Subsequently, the precision alignment mark on the wafer 2 is detected, whereby the fine adjustment of the position of the wafer in the horizontal direction and the direction of rotation is performed (step S301). By detecting the precision alignment mark on the wafer 2, the positional coordinate of the base pattern on the wafer is recorded as a value to the wafer stage coordinate at this stage to form a map centered at the base pattern. This map is used as the value of the center coordinate upon the transfer.

In this embodiment, the optional transfer position (hereinafter referred to as a representative transfer position) among the plural transfer positions on the surface of the wafer 2 is selected beforehand. The number of the representative transfer position is not particularly limited.

Then, at the stage where the mask substrate 1 and the wafer 2 are placed in a predetermined state before the above-mentioned pattern transfer, the wafer stage 3 is moved to the representative transfer position to perform a precise alignment of the wafer 2 (step S302). Subsequently, the press-contact unit 9 and the storing unit 11 are driven to press the mask substrate 1 against the wafer 2 and bring the height adjusting unit 4 into contact with the back surface of the wafer 2 (the surface of the wafer 2 opposite to the mask substrate 1) (step S303).

With this state, the positional deviation amount between the positional deviation detecting pattern on the mask substrate 1 at the representative transfer position and the positional deviation detecting pattern on the wafer 2 are optically measured at a predetermined position using the positional deviation distribution measuring unit 6, whereby the positional deviation distribution is measured (step S304). The obtained positional deviation distribution is input to the operation unit 7 to obtain the map h1 of the approximate value of h like the first embodiment.

Next, the operation unit 7 makes an approximate polynomial to the map h1 of the approximate value to obtain each coefficient of the polynomial, by the same manner as in the first embodiment. The obtained coefficient of the polynomial is sent to the control unit 5 as data. The control unit 5 obtains the height distribution information h2 for correcting the positional deviation distribution by using the coefficient of the polynomial received from the operation unit 7, and calculates the correction height distribution information h2 that should be given to each lattice point of the height adjusting unit 4 (step S305).

Then, the control unit 5 converts the calculated correction height distribution information h2 into the voltage that should be applied to each piezoelectric device of the height adjusting unit 4, and applies the voltage to the piezoelectric device to drive the same for adjusting the height distribution in the plane at the transfer position (step S306). The positional deviation between the mask substrate 1 and the wafer 2 can be cancelled by this height adjustment.

Next, the control unit 5 confirms the completion of the process for adjusting the height distribution in the plane at the transfer position, and then, transmits to the resist-curing light irradiating unit 8 an instruction signal for the light irradiation for the resist curing. The resist-curing light irradiating unit 8 irradiates ultraviolet light for the resist curing from the back surface of the mask substrate 1 in accordance with the instruction signal from the control unit 5, thereby transferring the resist pattern having the same shape of the pattern on the mask substrate 1 on the wafer 2 (step S307).

After the pattern is transferred by the irradiation of the ultraviolet light, the press-contact unit 9 and the storing unit 11 are separated from the wafer 2 (step S308). Then, the control unit 5 determines whether the next representative transfer position is present or not (step S309). When the next representative transfer position is present (Yes at step S309), the program returns to step S302 so as to drive the wafer stage 3 to move to the next representative transfer position. Then, the pattern transfer process at the representative transfer position is repeated by the same process.

On the other hand, when the next representative transfer position is not present (No at step S309), i.e., when pattern transfer at all the representative transfer positions on the wafer 2 is completed, the pattern transfer process at the other transfer position (hereinafter referred to as “normal transfer position”) where the positional deviation distribution is not measured by the above-mentioned process is then executed.

In order to execute the pattern transfer at the normal transfer position, the wafer stage 3 is firstly moved to the normal transfer position to perform the precise alignment of the wafer 2 (step S310). Then, the press-contact unit 9 and the storing unit 11 are driven to press the mask substrate 1 against the wafer 2 and bring the height adjusting unit 4 into contact with the back surface of the wafer 2 (the surface of the wafer 2 opposite to the mask substrate 1) (step S311).

Next, the control unit 5 converts the correction height distribution information h2 calculated upon performing the pattern transfer at the representative transfer position into the voltage that should be applied to each piezoelectric device of the height adjusting unit 4, and applies the voltage to the piezoelectric device to drive the same, thereby adjusting the height distribution in the plane at the transfer position (step S312). The positional deviation between the mask substrate 1 and the wafer 2 can be cancelled with this height adjustment.

The correction height distribution information h2 at the specific representative transfer position can be used for the correction height distribution information h2 used here. Further, the average of the whole correction height distribution information h2 at the plural representative transfer positions can be used, for example. The average of the correction height distribution information h2 at the representative transfer position at the neighborhood of the normal transfer position may be used. Further, the correction height distribution information h2 at the representative transfer position at the neighborhood of the normal transfer position is adjusted by using a predetermined correction equation, and the adjusted one may be used.

Next, the control unit 5 confirms the completion of the process for adjusting the height distribution in the plane at the transfer position, and then, transmits to the resist-curing light irradiating unit 8 an instruction signal for the light irradiation for the resist curing. The resist-curing light irradiating unit 8 irradiates ultraviolet light for the resist curing from the back surface of the mask substrate 1 in accordance with the instruction signal from the control unit 5, thereby transferring the resist pattern having the same shape of the pattern on the mask substrate 1 on the wafer 2 (step S313).

After the pattern is transferred by the irradiation of the ultraviolet light, the press-contact unit 9 and the storing unit 11 are separated from the wafer 2 (step S314). Then, the control unit 5 determines whether the next normal transfer position is present or not (step S315). When the next normal transfer position is present (Yes at step S315), the program returns to step S310 so as to drive the wafer stage 3 to move the same to the center coordinate of the next shot (transfer). Then, the transfer process is repeated by the same process.

On the other hand, when the next normal transfer position is not present (No at step S315), i.e., when all the desired shots (transfers) on the wafer 2 are completed, the press-contact unit 9 and the storing unit 11 are again separated from the wafer 2. After they are sufficiently separated, the wafer 2 on which the pattern has already been transferred is unloaded from the wafer chuck 10 (step S316), whereby a series of transfer process of the wafer 2 is completed. After that, the transfer to the next wafer 2 can be performed by the same process.

According to the pattern transfer method of the present embodiment, a high-quality pattern transfer having very small positional deviation distribution is made possible in which the partial distortion of the wafer 2 in the in-plane direction at the transfer position is corrected and the positioning precision between the mask substrate 1 and the wafer 2 is remarkably enhanced, like the case of the first embodiment.

Further, according to the pattern transfer method of the present embodiment, the positional deviation distribution at all of the plural transfer positions formed on a single wafer 2 is not measured to calculate the correction height distribution information, but the positional deviation distribution at the optional transfer position (representative transfer position) among the plural transfer positions formed on the wafer 2 is only measured to calculate the correction height distribution information. This correction height distribution information is applied to the other transfer position (normal transfer position) whose positional deviation distribution is not measured. Therefore, the pattern transfer can be carried out with good mass-productivity with a simple method.

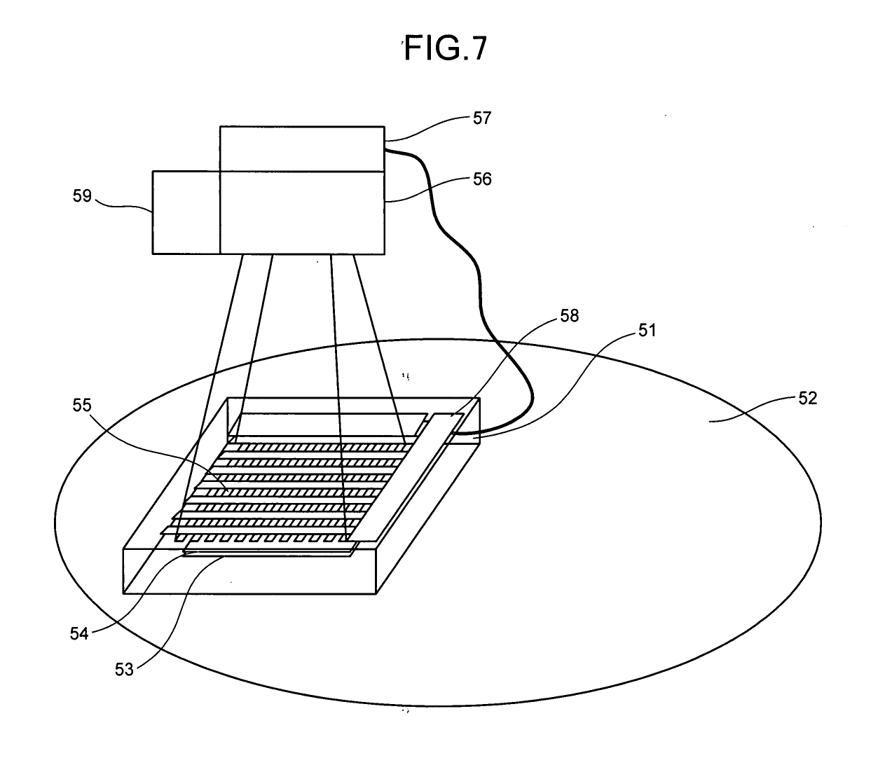

FIG. 7 is a structural view showing a schematic structure of a pattern transfer apparatus according to the fourth embodiment. This pattern transfer apparatus is for realizing a same size contact transfer by the pattern transfer method, like the pattern transfer apparatus according to the first embodiment. The pattern transfer apparatus is composed of a mask substrate 51, a positional deviation distribution measuring unit 56, an operation unit 57, and a resist-curing light irradiating unit 59. A mask substrate 51, a positional deviation distribution measuring unit 56, an operation unit 57, and a resist-curing light irradiating unit 59 respectively correspond to the above-mentioned mask substrate 1, the positional deviation distribution measuring unit 6, the operation unit 7, and the resist-curing light irradiating unit 8.

In addition to the above-mentioned these components, the pattern transfer apparatus according to this embodiment has a wafer stage 3, a control unit 5, a press-contact unit 9, a wafer chuck 10, and the like, like the pattern transfer apparatus of the first embodiment, wherein the parts common to those in the first embodiment are partly omitted from an illustrative viewpoint. Therefore, for these components, the above-mentioned explanation and FIG. 1 are referred to.

In the pattern transfer apparatus according to the present embodiment, the mask substrate 51, which is an original plate, is arranged so as to be opposite to the wafer 52, which is a substrate to which a pattern is to be transferred, as held at the press-contact unit 9. The wafer 52 is held at the wafer chuck 10 so as to be movable in the in-plane direction of the wafer stage 3 thereon.

As for the mask substrate 51, a crystal 54 that is a crystal of quartz is bonded by a direct bonding to the back surface of the transfer pattern unit 53 formed on a quartz glass having a thickness of 100 μm. The mask substrate 51 has formed thereon a thin-film transistor (TFT) made of zinc oxide (ZnO) known as a transparent semiconductor and a transparent electrode 55 made of indium tin oxide (ITO) and laminated in a lattice of 1 mm pitch. The crystal 54 is a transparent piezoelectric member having a piezoelectric effect, as is well known.

In the pattern transfer apparatus according to the present invention, the positional deviation measuring unit 56 can measure the relative positional deviation between the pattern on the mask substrate 51 and the pattern on the wafer 52 with the mask substrate 51 brought into pressure contact with the wafer 52. The result of this measurement is converted by the operation unit 57 into a control signal for the crystal 54 providing the piezoelectric effect, and transmitted to the control unit 58.

The resist-curing light irradiating unit 59 irradiates ultraviolet light, which is necessary for curing the resist, to the resist on the wafer 52 through the mask substrate 51 based upon the signal from the control unit 58 and the operation unit 57, after the positioning of the mask substrate 51 and the wafer 52 is completed.

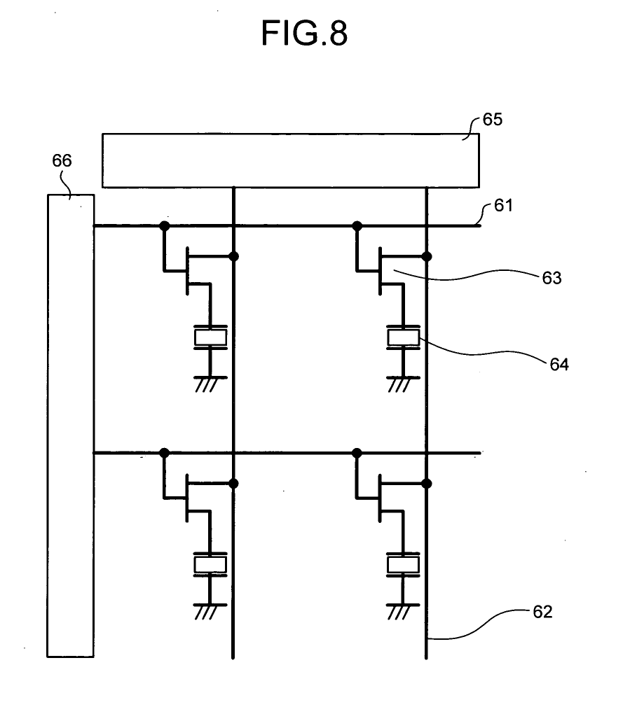

FIG. 8 is an equivalent circuit diagram for explaining the configuration of the mask substrate 51. The lattice transparent electrode 55 in FIG. 7 is divided into lines 61 and rows 62 as shown in FIG. 8. The lines 61 are connected to the gate of the TFT 63, and the rows 62 are connected to the source of the TFT 63. The crystal 54 explained in FIG. 7 is an insulator, so that it is electrically equivalent to the condenser divided in parallel. The condenser 64 shown in FIG. 8 corresponds to this condenser, one end of which is connected to the drain of the TFT 63 and the other end of which is connected to the ground electrode made of the wafer 52.

Since the condenser 64 functions as the piezoelectric device, it contracts in proportion to the charges accumulated at the condenser 64 at each lattice point (at the intersection of the line 61 and the row 62). Therefore, a line decoder 66 and a row decoder 65, which are a part of the control unit 58, are used to perform the circuit operation same as that of DRAM, whereby desired charges are accumulated at each lattice point, and hence, desired expansion distribution can be provided.

Specifically, supposing that the charges accumulated at each condenser is defined as Q, the electrostatic capacity is defined as C, the effective thickness of the piezoelectric device is defined as t, electromechanical coupling coefficient is defined as d, and Poisson's ratio of the mask substrate is defined as v, the following approximate equation (1) is established between the distortion v and the charge Q.

$$Q ∼ C \frac{t}{( 1 + ν ) d} div ( v ) \qquad ( 1 )$$

Accordingly, the charges Q that should be accumulated at each condenser 64 can be obtained from this approximate equation (1) with the measured positional deviation amount as an input. By forming this charge distribution, the positional deviation between the mask substrate 51 and the wafer 52 in the in-plane direction of the wafer can be cancelled.

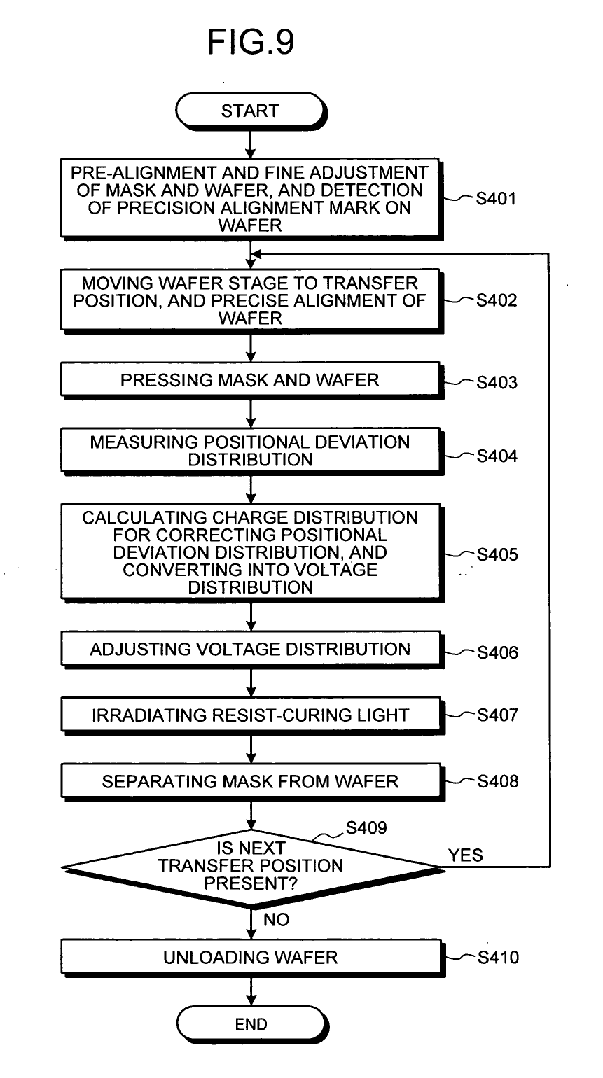

Subsequently, the actual pattern transfer method using the transfer apparatus according to the present embodiment will be explained with reference to FIG. 9. FIG. 9 is a flowchart for explaining a process flow of the pattern transfer method according to the present embodiment. Firstly, a pattern for detecting the positional deviation is formed beforehand on the mask substrate 51, which is an original plate, with the circuit pattern. It is to be noted that a part of the circuit pattern may be used for the detection of the positional deviation.

The wafer 52, which is a substrate to which a pattern is to be transferred, is, for example, a silicon wafer having a thickness of 720 μm. A base pattern is formed beforehand on the wafer 52, and ultraviolet curing type resist is applied thereon. The base pattern here includes the pattern for the detection of the positional deviation with the circuit pattern. It is to be noted that a part of the circuit pattern may also be used for the detection of the positional deviation.

The prepared mask substrate 51 is subject to a rough adjustment (pre-alignment) of the position in the horizontal direction and the rotation in the horizontal plane by a pre-alignment mechanism not shown (step S401), and then, fixed to the mask substrate chuck at the press-contact unit. Then, a fine adjustment in the position in the horizontal direction and the rotation in the rotating direction is performed by using a reference mark on the wafer stage (step S401).

The wafer 52 having the resist applied thereon is also subject to a rough adjustment (pre-alignment) in the position in the horizontal direction and the rotation in the horizontal plane with a notch defined as a reference by a pre-alignment mechanism not shown, like the mask substrate 51 (step S401), and then, fixed to the wafer chuck 10 on the wafer stage 3. The wafer 52 is fixed to the wafer chuck 10 by utilizing the portion of the periphery of the wafer 52 where the pattern is not formed.

Subsequently, the precision alignment mark on the wafer 52 is detected, whereby the fine adjustment of the position of the wafer in the horizontal direction and the direction of rotation is performed (step S401). By detecting the precision alignment mark on the wafer 52, the positional coordinate of the base pattern on the wafer is recorded as a value to the wafer stage coordinate at this stage to form a map centered at the base pattern. This map is used as the value of the center coordinate upon the transfer.

Then, at the stage where the mask substrate 51 and the wafer 52 are placed in a predetermined state before the above-mentioned pattern transfer, the wafer stage 3 is moved to the position of the center coordinate of the first shot (transfer) of the wafer 52 to perform a precise alignment of the wafer 52 (step S402), like the normal pattern transfer apparatus. Specifically, positioning is performed between the center coordinate of the first shot (transfer) of the wafer 52 and the center coordinate of the mask substrate 51. Subsequently, the press-contact unit 9 is driven to press the mask substrate 51 against the wafer 52 (step S403).

With this state, the positional deviation amount between the positional deviation detecting pattern on the mask substrate 51 and the positional deviation detecting pattern on the wafer 52 are optically measured at a predetermined position using the positional deviation distribution measuring unit 56, whereby the positional deviation distribution is measured (step S404). Supposing that the result of the measurement is defined as v(x, y) (notably, v is a two-dimensional vector amount), the positional deviation amount v(x, y) can be cancelled according to the above-mentioned principle, if Q is obtained by using the equation (1) from the obtained v(x, y). Since the v(x, y) is actually not a continuous value but a discrete value, the differentiation is approximated with the difference, and the map Q1 of the approximate value of Q is obtained at the operation unit 57.

The position of the positional deviation detecting pattern does not always agree with the lattice position of the transparent electrode 55. Therefore, the operation unit 57 makes an approximate polynomial to the map Q1 of the approximate value to obtain each coefficient of the polynomial by the least squares method. The obtained coefficient of the polynomial is sent to the control unit 58 as data.

The control unit 58 calculates the distribution information Q2 of the charges that should be accumulated at each lattice point using the received coefficient of the polynomial. Then, the control unit 58 converts the calculated charge distribution information Q2 into the distribution information of voltage that should be applied to each electrode at each lattice point via the row decoder 65 (S405). The control unit 58 then successively selects each line and circularly applies the obtained voltage to each row, thereby forming the charge distribution to the condenser 64 and forming the desired voltage distribution to the crystal 54 (step S406). Therefore, a distortion due to the piezoelectric effect of the crystal 54 is produced, and the partial correction of the mask substrate 51 in the in-plane direction of the pattern at the transfer position is performed, whereby the positional deviation between the mask substrate 51 and the wafer 52 can be cancelled.

Next, the control unit 58 confirms the completion of the process for forming the desired voltage distribution in the plane at the crystal 54, and then, transmits to the resist-curing light irradiating unit 59 an instruction signal for the light irradiation for the resist curing. The resist-curing light irradiating unit 59 irradiates ultraviolet light for the resist curing from the back surface of the mask substrate 51 in accordance with the instruction signal from the control unit 58, thereby transferring the resist pattern having the same shape of the pattern on the mask substrate 51 on the wafer 52 (step S407).

According to need, the positional deviation distribution may be measured again before the irradiation of the ultraviolet light for confirming whether the positional deviation is cancelled or not. With this operation, a transfer with more reliability can be performed. Further, the fine adjustment in the height may be performed again in accordance with the result of the re-measurement of the positional deviation distribution. This can more surely cancel the positional deviation, so that a transfer having more reliability can be performed. A feedback loop may be provided between the measurement of the positional deviation distribution and the height adjustment.

After the pattern is transferred by the irradiation of the ultraviolet light, the press-contact unit 9 is separated from the wafer 52 to make the mask substrate 51 apart from the wafer 52 (step S408). Then, the control unit 58 determines whether the next transfer position is present or not (step S409). When the next transfer position is present (Yes at step S409), the program returns to step S402 so as to drive the wafer stage 3 to move the same to the center coordinate of the next shot (transfer). Then, the transfer process is repeated by the same process.

On the other hand, when the next transfer position is not present (No at step S409), i.e., when all the desired shots (transfers) on the wafer 52 are completed, the press-contact unit 9 is again separated from the wafer 52. After they are sufficiently separated, the wafer 52 on which the pattern has already been transferred is unloaded from the wafer chuck 10 (step S410), whereby a series of transfer process of the wafer 52 is completed. After that, the transfer to the next wafer 52 can be performed by the process same as steps S401 to S410.

The aforesaid series of transfer process is executed using the pattern transfer apparatus according to the present embodiment, whereby a high-quality pattern transfer having very small positional deviation distribution is made possible in which the partial correction of the mask substrate 51 in the in-plane direction at the transfer position is performed by using the piezoelectric effect of the crystal 54 and the positioning precision between the mask substrate 51 and the wafer 52 is remarkably enhanced.

In the fifth embodiment, another pattern transfer method using the pattern transfer apparatus according to the above-mentioned fourth embodiment will be explained. It is to be noted that, since the pattern transfer apparatus according to this embodiment is the same as that in the fourth embodiment, FIGS. 7, 8 and 1 and the above-mentioned explanation are referred to, and the detailed explanation thereof is not repeated.

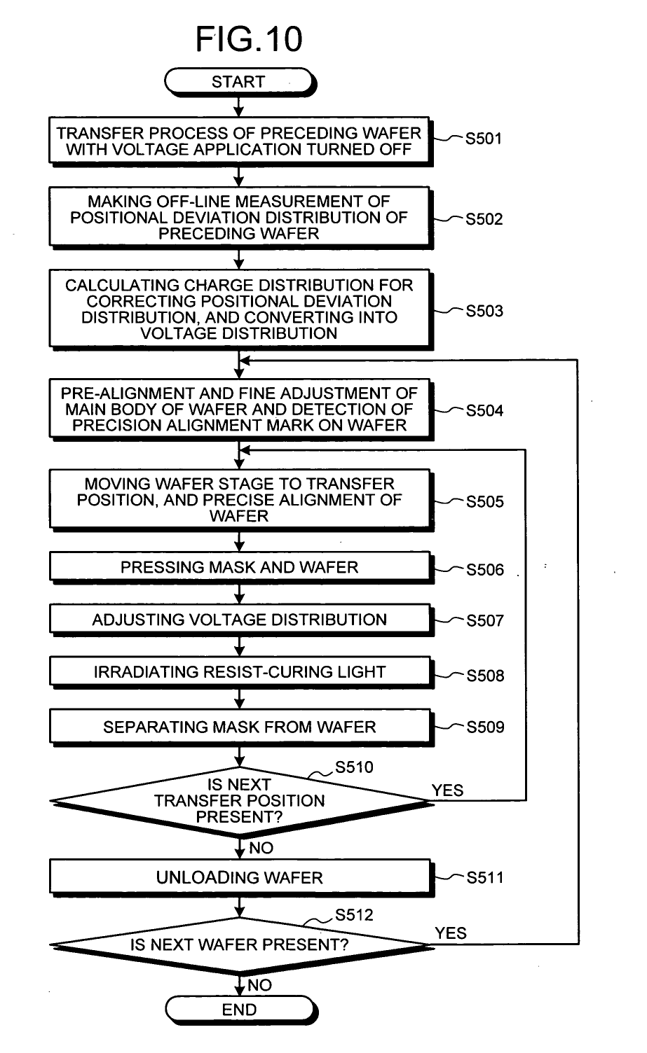

This embodiment explains the pattern transfer method in which the reproducibility in the positional deviation distribution of the wafer is high, such as plural wafers manufactured by, for example, the same lot through the same process. When the reproducibility in the positional deviation distribution is high, and the measurement of the positional deviation distribution for each wafer or the measurement of the positional deviation distribution for each shot in each wafer is unnecessary, the following simple method can be employed. This will be explained hereinafter with reference to FIG. 10. FIG. 10 is a flowchart for explaining a process flow of the pattern transfer method according to this embodiment.

Firstly, a pattern transfer is performed to a dummy wafer (hereinafter referred to as preceding wafer 52a) for measuring the positional deviation distribution and the positional deviation distribution at the shot (transfer) in the wafer. The normal pattern transfer to the preceding wafer 52a is carried out with the voltage application to the crystal 54 turned off, i.e., with the whole portion of the crystal 54 not displaced (step S501). In this pattern transfer, the above-mentioned steps S401 to S403 are executed as the preliminary process.

Next, the preceding wafer 52a to which the pattern has been transferred is unloaded from the pattern transfer apparatus, and the positional deviation distribution v(x, y) is measured by using the off-line positional deviation measuring device (step S502). It is to be noted that the off-line measuring function may be provided to the positional deviation distribution measuring unit 56 of the pattern transfer apparatus for measuring the positional deviation distribution. Further, the obtained positional deviation distribution is input to the operation unit 57, whereby the map Q1 of the approximate value Q is obtained by the same manner as in the fourth embodiment.

Subsequently, the operation unit 57 makes an approximate polynomial to the map Q1 of the approximate value to obtain each coefficient of the polynomial by the same manner as in the fourth embodiment. The obtained coefficient of the polynomial is sent to the control unit 58 as data. The control unit 58 calculates the distribution information Q2 of the charges that should be applied to each electrode at each lattice point using the coefficient of the polynomial received from the operation unit 57. Then, the control unit 58 converts the calculated distribution information Q2 of the charges into the distribution information of the voltage that should be applied to each electrode at each lattice point via the row decoder 65 (step S503).

Next, the pattern transfer to the main body wafer (hereinafter referred to as wafer 52), which is to be a product, is carried out. Since the rough adjustment (pre-alignment) and fine adjustment of the mask substrate 51 has already been completed as the preliminary process, the rough adjustment (pre-alignment) and fine adjustment for the wafer 52 having the resist applied thereon is executed. Specifically, the rough adjustment (pre-alignment) of the position in the horizontal direction and the rotation in the horizontal plane is carried out with the notch defined as a reference by using a pre-alignment mechanism not shown (step S504), like the case of the mask substrate 51, and then, the wafer 52 is fixed to the wafer chuck 10 on the wafer stage 3. The wafer 52 is fixed to the wafer chuck 10 by utilizing the peripheral portion of the wafer 52 where the pattern is not formed.

Subsequently, the precision alignment mark on the wafer 52 is detected, whereby the fine adjustment of the position of the wafer in the horizontal direction and the direction of rotation is performed (step S504). By detecting the precision alignment mark on the wafer 52, the positional coordinate of the base pattern on the wafer is recorded as a value to the wafer stage coordinate at this stage to form a map centered at the base pattern. This map is used as the value of the center coordinate upon the transfer.

Then, at the stage where the mask substrate 51 and the wafer 52 are placed in a predetermined state before the above-mentioned pattern transfer, the wafer stage 3 is moved to the position of the center coordinate of the first shot (transfer) of the wafer 52 to perform a precise alignment of the wafer 52 (step S505), like the normal pattern transfer apparatus. Specifically, positioning is performed between the center coordinate of the first shot (transfer) of the wafer 52 and the center coordinate of the mask substrate 51. Subsequently, the press-contact unit 9 is driven to press the mask substrate 51 against the wafer 52 (step S506).

Next, the control unit 58 successively selects each line and circularly applies the obtained voltage to each row based on the distribution information of the voltage that should be applied to each electrode at each lattice point, which is obtained at the preceding wafer 52a, thereby forming the charge distribution to the condenser 64 and forming the desired voltage distribution to the crystal 54 (step S507). Therefore, a distortion due to the piezoelectric effect of the crystal 54 is produced, and the partial correction of the mask substrate 51 in the in-plane direction of the pattern at the transfer position is performed, whereby the positional deviation between the mask substrate 51 and the wafer 52 can be cancelled.

Next, the control unit 58 confirms the completion of the process for forming the desired voltage distribution in the plane of the crystal 54, and then, transmits to the resist-curing light irradiating unit 59 an instruction signal for the light irradiation for the resist curing. The resist-curing light irradiating unit 59 irradiates ultraviolet light for the resist curing from the back surface of the mask substrate 51 in accordance with the instruction signal from the control unit 58, thereby transferring the resist pattern having the same shape of the pattern on the mask substrate 51 on the wafer 52 (step S508).

After the pattern is transferred by the irradiation of the ultraviolet light, the press-contact unit 9 is separated from the wafer 52 so as to make the mask substrate 51 apart from the wafer 52 (step S509). Then, the control unit 58 determines whether the next transfer position is present or not (step S510). When the next transfer position is present (Yes at step S510), the program returns to step S505 so as to drive the wafer stage 3 to move the same to the center coordinate of the next shot (transfer). Then, the transfer process is repeated by the same process.

On the other hand, when the next transfer position is not present (No at step S510), i.e., when all the desired shots (transfers) on the wafer 52 are completed, the press-contact unit 9 is again separated from the wafer 52. After they are sufficiently separated, the wafer 52 on which the pattern has already been transferred is unloaded from the wafer chuck 10 (step S511). After the wafer 52 is unloaded from the wafer chuck 10, the control unit 58 determines whether the next wafer 52 to which the pattern transfer is to be executed is present or not from the presence of the input of a continuation processing signal, for example (step S512).

When there is the next wafer 52 to which the pattern transfer is to be executed (Yes at step S512), the program returns to step S504 to repeat the transfer process. As described above, the pattern transfer to the succeeding wafer 52 of the same lot is carried out, whereby the pattern transfer is made possible in which the partial correction of the mask substrate 51 in the in-plane direction of the pattern at the transfer position is performed with the equivalent precision.

On the other hand, when the next wafer 52 to which the pattern transfer is to be executed is not present (No at step S512), a series of transfer process to the wafer 52 of the same lot is completed. After that, the pattern transfer to the wafer 52 for each lot can be carried out by performing the process same as that described above to the wafer 52 of the other lot.

In the above-mentioned pattern transfer process, the pattern transfer process of the wafer 52 is performed by using the charge distribution information Q2 calculated using the preceding wafer 52a. In this case, the pattern transfer process can be executed by using the charge distribution information Q2 different for every transfer position. Further, it is possible to execute the pattern transfer by using the charge distribution information Q2 same for all transfer positions.

According to the pattern transfer method of the present embodiment, a high-quality pattern transfer having very small positional deviation distribution is made possible in which the partial correction of the mask substrate 51 in the in-plane direction at the transfer position is performed by using the piezoelectric effect of the crystal 54 and the positioning precision between the mask substrate 51 and the wafer 52 is remarkably enhanced, like the fourth embodiment.

Further, according to the pattern transfer method of the present embodiment, when the reproducibility of the positional deviation distribution of the wafer is high such as plural wafers manufactured with the same lot through the same process, the data of the preceding wafer 52a is fed back, whereby the partial correction of the mask substrate 51 in the in-plane direction of the pattern at the transfer position is performed with the equivalent precision without measuring the positional deviation distribution for each wafer, or without measuring the positional deviation distribution for every shot in each wafer. Therefore, the pattern transfer can be carried out with good mass-productivity.

In the sixth embodiment, another pattern transfer method using the pattern transfer apparatus according to the above-mentioned fourth embodiment will be explained. It is to be noted that, since the pattern transfer apparatus according to this embodiment is the same as that in the fourth embodiment, FIGS. 7, 8 and 1 and the above-mentioned explanation are referred to, and the detailed explanation thereof is not repeated.

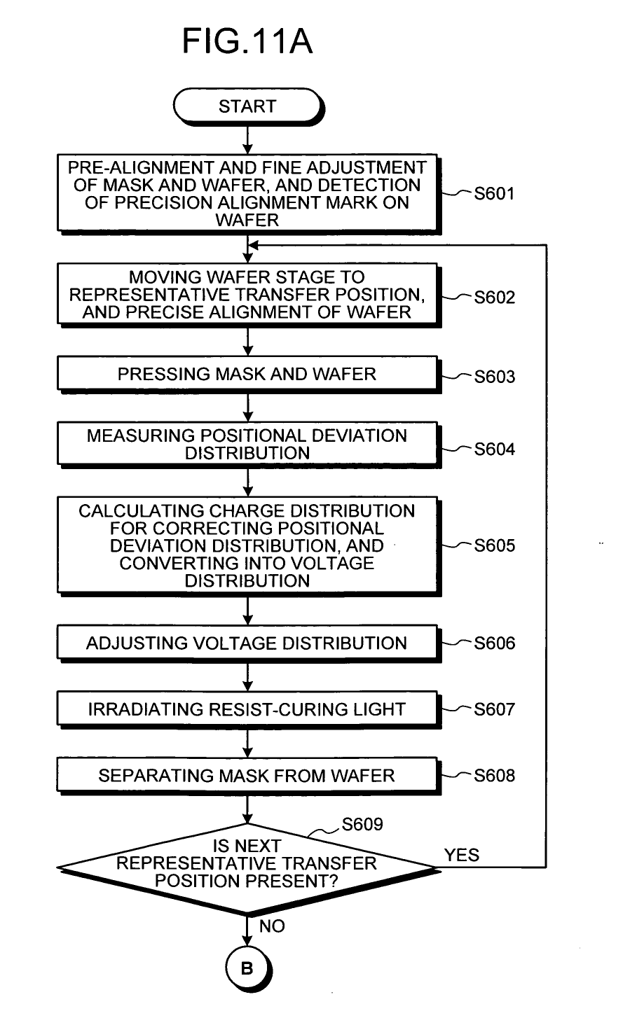

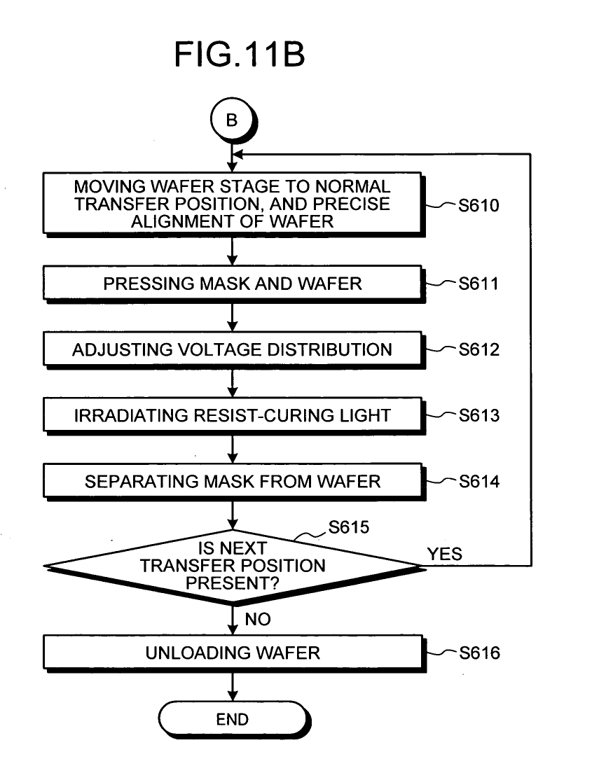

When a great difference is not produced in the positional deviation for every shot (transfer) in each wafer, for example, the following simple method can be employed. In the pattern transfer method according to this embodiment, the positional deviation distribution for the optional representative transfer position among plural transfer positions formed on a single wafer 52 is only measured to calculate the charge distribution information Q2, and the charge distribution information Q2 at the representative transfer position is applied to the other transfer positions. The pattern transfer method of this embodiment will be explained hereinafter with reference to FIGS. 11A and 11B. FIGS. 11A and 11B are flowcharts for explaining the process flow of the pattern transfer according to this embodiment.

The prepared mask substrate 51 is subject to a rough adjustment (pre-alignment) of the position in the horizontal direction and the rotation in the horizontal plane by a pre-alignment mechanism not shown (step S601), and then, fixed to the mask substrate chuck at the press-contact unit 9. Then, a fine adjustment in the position in the horizontal direction and the rotation in the rotating direction is performed by using a reference mark on the wafer stage 3 (step S601).

The wafer 52 having the resist applied thereon is also subject to a rough adjustment (pre-alignment) in the position in the horizontal direction and the rotation in the horizontal plane with a notch defined as a reference by a pre-alignment mechanism not shown, like the mask substrate (step S601), and then, fixed to the wafer chuck 10 on the wafer stage 3. The wafer 52 is fixed to the wafer chuck 10 by utilizing the portion of the periphery of the wafer 52 where the pattern is not formed.

Subsequently, the precision alignment mark on the wafer 52 is detected, whereby the fine adjustment of the position of the wafer in the horizontal direction and the direction of rotation is performed (step S601). By detecting the precision alignment mark on the wafer 52, the positional coordinate of the base pattern on the wafer is recorded as a value to the wafer stage coordinate at this stage to form a map centered at the base pattern. This map is used as the value of the center coordinate upon the transfer.

In this embodiment, the optional transfer position (hereinafter referred to as a representative transfer position) among the plural transfer positions on the surface of the wafer 52 is selected beforehand. The number of the representative transfer position is not particularly limited.

Then, at the stage where the mask substrate 51 and the wafer 52 are placed in a predetermined state before the above-mentioned pattern transfer, the wafer stage 3 is moved to the representative transfer position to perform a precise alignment of the wafer 52 (step S602). Subsequently, the press-contact unit 9 is driven to press the mask substrate 51 against the wafer 52 (step S603).

With this state, the positional deviation amount between the positional deviation detecting pattern on the mask substrate 51 at the representative transfer position and the positional deviation detecting pattern on the wafer 52 are optically measured at a predetermined position using the positional deviation distribution measuring unit 56, whereby the positional deviation distribution is measured (step S604). The obtained positional deviation distribution is input to the operation unit 57 to obtain the map Q1 of the approximate value of Q like the fourth embodiment.

Next, the operation unit 57 makes an approximate polynomial to the map Q1 of the approximate value to obtain each coefficient of the polynomial, by the same manner as in the fourth embodiment. The obtained coefficient of the polynomial is sent to the control unit 58 as data. The control unit 58 calculates the distribution information Q2 of the charges that should be accumulated at each lattice point on each electrode by using the coefficient of the polynomial received from the operation unit 57. Then, the control unit 58 converts the calculated charge distribution information Q2 into the distribution information of the voltage that should be applied to each electrode at each lattice point through the row decoder 65 (step S605).

Then, the control unit 58 successively selects each line and circularly applies the obtained voltage to each row, thereby forming the charge distribution to the condenser 64 and forming the desired voltage distribution to the crystal 54 (step S606). Therefore, a distortion due to the piezoelectric effect of the crystal 54 is produced, and the partial correction of the mask substrate 51 in the in-plane direction of the pattern at the transfer position is performed, whereby the positional deviation between the mask substrate 51 and the wafer 52 can be cancelled.

Next, the control unit 58 confirms the completion of the process for forming the desired charge distribution in the plane of the crystal 54, and then, transmits to the resist-curing light irradiating unit 59 an instruction signal for the light irradiation for the resist curing. The resist-curing light irradiating unit 59 irradiates ultraviolet light for the resist curing from the back surface of the mask substrate 51 in accordance with the instruction signal from the control unit 58, thereby transferring the resist pattern having the same shape of the pattern on the mask substrate 51 on the wafer 52 (step S607).

After the pattern is transferred by the irradiation of the ultraviolet light, the press-contact unit 9 is separated from the wafer 52 so as to make the mask substrate 51 apart from the wafer 52 (step S608). Then, the control unit 58 determines whether the next representative transfer position is present or not (step S609). When the next representative transfer position is present (Yes at step S609), the program returns to step S602 so as to drive the wafer stage 3 to move the same to the center coordinate of the next shot (transfer). Then, the transfer process is repeated by the same process as described above.

On the other hand, when the next representative transfer position is not present (No at step S609), i.e., when pattern transfer at all the representative transfer positions on the wafer 52 is completed, the pattern transfer process at the other transfer position (hereinafter referred to as “normal transfer position”) where the positional deviation distribution is not measured by the above-mentioned process is then executed.

In order to execute the pattern transfer at the normal transfer position, the wafer stage 3 is firstly moved to the normal transfer position to do the precise alignment of the wafer 52 (step S610). Then, the press-contact unit 9 is driven to press the mask substrate 51 against the wafer 52 (step S611).

Next, the control unit 58 successively selects each line and circularly applies the obtained voltage to each row based on the distribution information of the voltage that should be applied to each electrode at each lattice point, which is obtained upon performing the pattern transfer at the representative transfer position, thereby forming the charge distribution to the condenser 64 and forming the desired voltage distribution to the crystal 54 (step S612). Therefore, a distortion due to the piezoelectric effect of the crystal 54 is produced, and the partial correction of the mask substrate 51 in the in-plane direction of the pattern at the transfer position is performed, whereby the positional deviation between the mask substrate 51 and the wafer 52 can be cancelled.

The voltage distribution information at the specific representative transfer position can be used for the voltage distribution information used here. Further, the average of the whole voltage distribution information at the plural representative transfer positions can be used, for example. The average of the voltage distribution information at the representative transfer position at the neighborhood of the normal transfer position may be used. Further, the voltage distribution information at the representative transfer position at the neighborhood of the normal transfer position is adjusted by using a predetermined correction equation, and the adjusted one may be used.

Next, the control unit 58 confirms the completion of the process for forming the desired voltage distribution in the plane of the crystal 54, and then, transmits to the resist-curing light irradiating unit 59 an instruction signal for the light irradiation for the resist curing. The resist-curing light irradiating unit 59 irradiates ultraviolet light for the resist curing from the back surface of the mask substrate 51 in accordance with the instruction signal from the control unit 58, thereby transferring the resist pattern having the same shape of the pattern on the mask substrate 51 on the wafer 52 (step S613).

After the pattern is transferred by the irradiation of the ultraviolet light, the press-contact unit 9 is separated from the wafer 52 so as to make the mask substrate 51 apart from the wafer 52 (step S614). Then, the control unit 58 determines whether the next normal transfer position is present or not (step S615). When the next normal transfer position is present (Yes at step S615), the program returns to step S610 so as to drive the wafer stage 3 to move the same to the center coordinate of the next shot (transfer). Then, the transfer process is repeated by the same process.

On the other hand, when the next normal transfer position is not present (No at step S615), i.e., when all the desired shots (transfers) on the wafer 2 are completed, the press-contact unit 9 is again separated from the wafer 52. After they are sufficiently separated, the wafer 52 on which the pattern has already been transferred is unloaded from the wafer chuck 10 (step S616), whereby a series of transfer process of the wafer 52 is completed. After that, the transfer to the next wafer 52 can be performed by the same process.

According to the pattern transfer method of the present embodiment, a high-quality pattern transfer having very small positional deviation distribution is made possible in which the partial correction of the mask substrate 51 in the in-plane direction at the transfer position is performed and the positioning precision between the mask substrate 51 and the wafer 52 is remarkably enhanced, like the fourth embodiment.

Further, according to the pattern transfer method of the present embodiment, the positional deviation distribution at all of the plural transfer positions formed on a single wafer 52 is not measured, but the positional deviation distribution at the optional transfer position (representative transfer position) among the plural transfer positions formed on the wafer 52 is only measured. The data at the representative transfer position is fed back and the same data is applied to the other transfer position (normal transfer position) whose positional deviation distribution is not measured. Therefore, the pattern transfer can be carried out with good mass-productivity with a simple method without measuring the positional deviation distribution at each transfer position.

The present invention is not limited to the above-mentioned each embodiment. In the above-mentioned embodiments, a step and flash imprint lithography is utilized that uses an ultraviolet curing type resist. However, the present invention is applicable to a microcontact lithography in which a resist material is adhered onto the leading end of the mask substrate and only the leading end is brought into contact with the wafer, thereby forming a pattern.

The present invention can also be applied to a batch transfer in which a pattern is collectively formed on the whole surface of the wafer without moving the wafer stepwise. Moreover, a PZT or crystal is used as the piezoelectric device, but other materials such as lead lanthanum zirconate titanate (PLZT) can be used. The present invention can be modified within the range not departing from the spirit of the present invention.

In the present invention, it is unnecessary to form the mask substrate and the wafer, which has been not yet subject to the transfer process, in the idealistic flat state in the in-plane direction. Even when the mask substrate and the wafer, which has been not yet subject to the transfer process, are not in the idealistic flat state in the in-plane direction, a high-quality pattern transfer having very small positional deviation distribution is made possible in which the positioning precision between the mask substrate and the wafer is remarkably enhanced due to the execution of the correction, like the above-mentioned case.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern transfer method comprising:
performing positioning between a transfer position of a pattern forming surface of a transfer original plate on which a pattern to be transferred is formed and a transferred position of a transferred surface of a transferred substrate to which the pattern is to be transferred;
contacting the pattern forming surface with the transferred surface; and
partly correcting the positional deviation between the transfer position of the pattern forming surface and the transferred position of the transferred surface in the in-plane direction, after the positioning is performed.

2. The method according to claim 1, wherein the positional deviation is partly corrected by partly correcting the transferred position of the transferred surface in the in-plane direction, after the positioning is performed.

3. The method according to claim 2, wherein the distortion in the in-plane direction at the transferred position of the transferred surface is partly adjusted through the adjustment in part of the height of a part of the transferred position of the transferred surface, thereby correcting the partial positional deviation at the transferred position in the in-plane direction.

4. The method according to claim 3, wherein the adjustment in part of the height of the part of the transferred position is performed by pressing partly a surface of the transferred substrate which is opposed to the transferred surface.

5. The method according to claim 2, further comprising:
forming positional deviation distribution information by measuring the positional deviation between the transfer position of the pattern forming surface and the transferred position of the transferred surface in the in-plane direction, after the positioning is performed,
wherein the positional deviation is partly corrected by partly correcting the transferred position of the transferred surface in the in-plane direction based on the positional deviation distribution information.

6. The method according to claim 1, wherein the positional deviation is partly corrected by partly correcting the transfer position of the pattern forming surface in the in-plane direction, after the positioning is performed.

7. The method according to claim 6, further comprising:
forming positional deviation distribution information by measuring the positional deviation between the transfer position of the pattern forming surface and the transferred position of the transferred surface in the in-plane direction, after the positioning is performed,
wherein the positional deviation is partly corrected by partly correcting the transfer position of the pattern forming surface in the in-plane direction based on the positional deviation distribution information.

8. The method according to claim 6, wherein the positional deviation is partly corrected by partly correcting the transfer position on the pattern forming surface in the in-plane direction using the distortion generated by a material having a piezoelectric effect.

9. The method according to claim 1, wherein the pattern on the pattern forming surface is transferred onto the transferred surface by a lithography technique, after the positional deviation is partly corrected.

10. A pattern transfer apparatus comprising:
a press-contact unit that presses a pattern forming surface of a transfer original plate on which a pattern to be transferred is formed and a transferred surface of a transferred substrate to which a resist film is to be applied and the pattern is to be transferred, thereby bringing the pattern forming surface and the transferred surface into contact with each other;
a positioning unit that positions the transfer position of the pattern forming surface and the transferred position of the transferred surface;
a positional deviation correcting unit that partly corrects the positional deviation in the in-plane direction between the transfer position of the pattern forming surface and the transferred position of the transferred surface at the contact surface of the pattern forming surface and the transferred surface; and
a light source that irradiates light to expose the resist film on the transferred substrate.

11. The apparatus according to claim 10, wherein the positional deviation correcting unit partly corrects the positional deviation by partly correcting the transferred position of the transferred surface in the in-plane direction at the contact surface.

12. The apparatus according to claim 11, wherein the positional deviation correcting unit partly corrects the positional deviation by partly adjusting the height of a part of the transferred position at the contact surface.

13. The apparatus according to claim 12, wherein the positional deviation correcting unit presses partly a surface of the transferred substrate which is opposed to the transferred surface so as to partly adjust the height of the part of the transferred position.

14. The apparatus according to claim 10, wherein the positional deviation correcting unit partly corrects the positional deviation by partly correcting the transfer position of the pattern forming surface in the in-plane direction at the contact surface.
